(19) United States
(12) Patent Application Publication
(10) Pub. No.: US 2008/0008787 A1
(43) Pub. Date: Jan. 10, 2008

(54) METHODS OF FRYING FOOD USING LOW-LINOLENIC-ACID SOYBEAN OIL

(76) Inventors: Frank R. Kincs, Bourbonnais, IL (US); Pamela Teran, Bourbonnais, IL (US)

Correspondence Address: MCANDREWS HELD & MALLOY, LTD, 500 WEST MADISON STREET, SUITE 3400, CHICAGO, IL, 60661, US

(21) Appl. No.: 11/773,813

(22) Filed: Jul. 5, 2007

Related U.S. Application Data
(60) Provisional application No. 60/806,682, filed on Jul. 6, 2006.

(51) Int. Cl. A23L 1/01; A23L 1/164; A23L 1/217

(52) U.S. Cl. 426/89; 426/438; 426/560; 426/637

(57) ABSTRACT

A frying medium consisting essentially of unmodified low-linolenic-acid soybean oil that contains relatively little saturated fat, and essentially no trans fatty acid, is disclosed. Food fried in this medium has properties comparable to those of food fried in partially hydrogenated higher trans oils. The frying medium can comprise a minor proportion of another type of low linolenic oil, such as cottonseed oil or palm oil, blended with the soybean oil as from 1 to 49 wt. %, alternatively 1 to 25 wt. %, alternatively 1 to 10 wt. %, alternatively 1 to 5 wt. % of the frying medium. The soybean oil of the frying medium can have from 5 wt. % to 15 wt. % palmitic acid; from 2 wt. % to 10 wt. % stearic acid; from 20 wt. % to 50 wt. % oleic acid; from 30 wt. % to 60 wt. % linoleic acid; and from 0.2 wt. % to 3.5 wt. % linolenic acid.

### CROSS-REFERENCE TO RELATED APPLICATIONS

Priority is claimed to provisional application 60/806,682, filed Jul. 6, 2006. Provisional application 60/806,682 is incorporated by reference in its entirety.

### BACKGROUND OF THE INVENTION

Frying shortening compositions based on soybean oil are in common use. Common soybean oil contains a substantial fraction of polyunsaturated C₁₈ fatty acids, in particular oleic acid (mono-unsaturated), linoleic acid (di-unsaturated), and linolenic acid (tri-unsaturated). As is well known, the soybean oil does not contain a substantial proportion of free fatty acids. The fatty acids are present in the form of glycerides, predominantly triglycerides. The weight of each fraction represents the weight in the form of the free fatty acid.

A representative classic fatty acid profile for soybean oil is:

| Species | Representative Profile |
|---|---|
| Stearic (0 C═C) | 4 wt. % |
| Oleic (1 C═C) | 23.4 wt. % |
| Linoleic (2 C═C) | 53.2 wt. % |
| Linolenic (3 C═C) | 7.8 wt. % |
| Other (mostly Palmitic) | 11.6 wt. % |
| Total | 100.0 wt. % |

### Kirk-Othmer ENCYCLOPEDIA OF CHEMICAL TECHNOLOGY (4^{th} Ed.), Vol. 10, page 267.

In the past, soybean oil has been partially hydrogenated to reduce the proportion of unsaturated fatty acids, for the purpose of increasing its stability and raising its melting point to make more it more suitable as frying shortening. Unsaturated fatty acids decompose readily under heat and exposure to oxygen, leading to rancidity. Partial hydrogenation, however, has the undesired side effect of producing undesirable trans fatty acids, which are now required to be specified in nutritional labeling in the United States.

Recently, soybeans have been bred to naturally produce soybean oil having a different fatty acid profile, containing less linolenic acid and more oleic acid. One such soybean oil product is Treus™ (formerly known as Nutrium) soybean oil, which has a linolenic acid content of less than 3 percent (Nutrium and Treus™ are trademarks of Pioneer Hi-Bred International, Inc.).

U.S. Pat. No. 5,850,030, disclosing low linolenic soybean oil, states: “The soybean vegetable oil of the present invention in view of the reduced linolenic acid content is particularly suited for use in industrial and food applications where improved flavor stability is sought. For instance, when the oil is endogenously formed while under the influence of the combined presence of the three homozygous recessive gene pairs, the level of linolenic acid can be sufficiently reduced to extend the shelf-life of products in which it is incorporated and to perform better as a heat-transfer medium in applications such as cooking or frying. In some applications hydrogenation to increase stability is rendered unnecessary, and this obviates the formation of trans-fatty acids which some consumers prefer to minimize in the diet.” This statement can also be found in U.S. Pat. No. 6,133,509.

Other U.S. Patents potentially of interest include U.S. Pat. Nos. 6,639,132; 6,060,647; 6,025,509; 5,986,118; 5,795,969; 5,763,745; 5,750,846; 5,714,670; 5,714,669; 5,714,668; 5,710,369; 5,557,037; 5,534,425; and 5,530,183.

### BRIEF SUMMARY OF THE INVENTION

The present inventors have found, surprisingly, that snack and restaurant foods can be fried in a frying medium consisting essentially of unmodified low-linolenic-acid soybean oil that has not been hydrogenated or blended with saturated fat, and thus contains relatively little saturated fat and essentially no trans fatty acid, yielding fried foods that have acceptable sensory properties comparable to, alternatively equally acceptable to consumers as, alternatively indistinguishable by consumers from, those of food fried in partially hydrogenated higher trans oils. “Essentially no trans fatty acid” means no more trans fatty acid than the small amounts formed by the deodorization process.

Optionally, the frying medium can comprise a minor proportion of another type of low linolenic oil, such as cottonseed oil or palm oil, blended with the soybean oil as from 1 to 49 wt. %, alternatively 1 to 25 wt. %, alternatively 1 to 10 wt. %, alternatively 1 to 5 wt. % of the frying medium.

Optionally, the frying medium can comprise a minor proportion of soybean oil, canola oil, or high oleic canola oil, blended with the low linolenic soybean oil in the proportions stated in the previous paragraphs.

Broadly, the soybean oil of the frying medium can have the following range of fatty acid profiles: from 5 wt. % to 15 wt. % palmitic acid; from 2 wt. % to 10 wt. % stearic acid; from 20 wt. % to 50 wt. % oleic acid; from 30 wt. % to 60 wt. % linoleic acid; and from 0.2 wt. % to 3.5 wt. % linolenic acid. Each percentage of a fatty acid stated here is the percentage by weight of that fatty acid obtainable from the sample, compared to the weight of all fatty acids obtainable from the sample, after fully hydrolyzing the sample to form free fatty acids and glycerin. In other words, all percentages of fatty acids in the soybean oil are expressed in terms of the corresponding amount of free fatty acid.

Alternatively, the soybean oil can have the following narrower range of fatty acid profiles: from 8 wt. % to 12 wt. % palmitic acid; from 4 wt. % to 10 wt. % stearic acid; from 25 wt. % to 40 wt. % oleic acid; from 45 wt. % to 60 wt. % linoleic acid; and from 1 wt. % to 3 wt. % linolenic acid.

Alternatively, the soybean oil can have the following still narrower range of fatty acid profiles: from 9 wt. % to 11 wt. % palm itic acid; from 5 wt. % to 10 wt. % stearic acid; from 26 wt. % to 35 wt. % oleic acid; from 45 wt. % to 54 wt. % linoleic acid; and from 2 wt. % to 3 wt. % linolenic acid.

Alternatively, the soybean oil can have the following still narrower range of fatty acid profiles: from 9 wt. % to 11 wt. % palmitic acid; from 5 wt. % to 10 wt. % stearic acid; from 26 wt. % to 35 wt. % oleic acid; from 45 wt. % to 54 wt. % linoleic acid; and from 1 wt. % to 2 wt. % linolenic acid.

In each embodiment, the soybean oil can alternatively contain about 0.2 wt. % linolenic acid, alternatively about 0.3 wt. % linolenic acid, alternatively about 0.4 wt. % linolenic acid, alternatively about 0.5 wt. % linolenic acid, alternatively about 0.6 wt. % linolenic acid, alternatively about 0.7 wt. % linolenic acid, alternatively about 0.8 wt. % linolenic acid, alternatively about 0.9 wt. % linolenic acid, alternatively about 1 wt. % linolenic acid, alternatively about 1.1 wt. % linolenic acid, alternatively about 1.2 wt. % linolenic acid, alternatively about 1.3 wt. % linolenic acid, alternatively about 1.4 wt. % linolenic acid, alternatively about 1.5 wt. % linolenic acid, alternatively about 1.6 wt. % linolenic acid, alternatively about 1.7 wt. % linolenic acid, alternatively about 1.8 wt. % linolenic acid, alternatively about 1.9 wt. % linolenic acid, alternatively about 2 wt. % linolenic acid, alternatively about 2.1 wt. % linolenic acid, alternatively about 2.2 wt. % linolenic acid, alternatively about 2.3 wt. % linolenic acid, alternatively about 2.4 wt. % linolenic acid, alternatively about 2.5 wt. % linolenic acid, alternatively about 2.6 wt. % linolenic acid, alternatively about 2.7 wt. % linolenic acid, alternatively about 2.8 wt. % linolenic acid, alternatively about 2.9 wt. % linolenic acid, alternatively about 3 wt. % linolenic acid. Any of these individual proportions of linolenic acid can be combined with others to define a continuous range of proportions of linolenic acid.

An additive that may be useful in such oil is a foaming inhibitor, for example, dimethylpolysiloxane. An effective amount, such as 0.005 wt. %, can be used. Coloring, flavoring, and other additives can also be added.

Another aspect of the invention is fried food containing the above-described frying medium. One example of the fried food is a potato chip consisting essentially of potato solids and a frying medium consisting essentially of soybean oil that is essentially free of trans fatty acid and comprises from 0.2 wt. % to 3.5 wt. % linolenic acid, as a percentage of all fatty acids. Another example of the fried food is a French fry consisting essentially of potato solids and a frying medium consisting essentially of soybean oil that is essentially free of trans fatty acid and comprises from 0.2 wt. % to 3.5 wt. % linolenic acid, as a percentage of all fatty acid. Still another example of the fried food is a tortilla chip consisting essentially of corn solids and a frying medium consisting essentially of soybean oil that is essentially free of trans fatty acid and comprises from 0.2 wt. % to 3.5 wt. % linolenic acid, as a percentage of all fatty acid.

Yet another example of a class of fried foods is fried food consisting essentially of a food, breading, and a frying medium consisting essentially of soybean oil that is essentially free of trans fatty acid and comprises from 0.2 wt. % to 3.5 wt. % linolenic acid, as a percentage of all fatty acid. The food constituent can be a meat such as chicken, fish, clam strips, or others, a vegetable such as zucchini, potato solids, or jalapeno pepper, a dairy product such as cheese, a pastry such as doughnut dough, and others. The breading can be any material with which the food is coated to accept the frying medium or brown during frying. The frying medium can be any of the previously described examples.

### WORKING EXAMPLES

In the following working examples, the following soybean oil samples were used to fry various foods:

| | Ultra Low | Nutrium Low |
|---|---|---|
| Fatty Acid, wt. % | Linolenic Oil | Lin Oil |
| C14:0, Myristic | 0.07 | 0.07 |
| C16:0, Palmitic | 9.74 | 9.8 to 10.6 |
| C18:0, Stearic | 5.72 | 4.3 to 4.8 |
| C18:1, Oleic | 28.66 | 24.4 to 25.5 |
| C18:2, Linoleic | 52.83 | 55.6 to 56.3 |
| C18:3, Linolenic | 1.19 | 2.3 to 2.9 |
| C20:0, Arachidic | 0.43 | 0.32 to 0.37 |
| C20:1, Eicosenoic | 0.24 | 0.17 |
| C22:0, Behenic | 0.42 | 0.35 to 0.37 |
| C24:0, Lignoceric | 0.13 | 0.12 |
| Total | 99.43 | |

Treus™ (formerly known as Nutrium) Low Lin (or “LL”) oil is a low-linolenic soybean oil. Ultra Low Linolenic or “ULL” soybean oil is a recently-developed ultra-low-linolenic soybean oil that contains less linolenic acid, as well as more stearic and oleic acids and less linoleic acid than Nutrium Low Lin soybean oil.

### Example 1

### Tortilla Chip Frying Study

Treus™ low linolenic soybean oil and ultra-low linolenic soybean oil (ULLS) were tested in tortilla chips applications against two controls: a partially hydrogenated soybean oil and refined, bleached, and deodorized (RBD) soybean oil (also referred to as commodity soybean oil or soybean salad oil), to determine if the test oils can be used as a trans alternative in snack applications.

The test shortenings and control shortenings were used in Wells Fryers to prepare tortilla chips for evaluation. Frozen raw tortilla chips were fried at 370° F. (188° C.) for 90 seconds. A full batch of tortilla chips weighed 100 grams per fryer basket. Approximately 45 lbs. of frozen raw tortilla chips were fried in each fryer sample to break in the oil prior to collecting fried chips for the test.

Approximately 30 lbs. of tortilla chips were fried in each fryer sample and collected for packaging. Fried tortilla chips were weighed into 5 oz. foil bags, labeled according to sample type and sealed for storage. Bagged chips were stored at 85° F. (29° C.) for a total of 6 months' storage. Oil samples were collected from fryers before, during and after frying and submitted for analytical testing. Fried tortilla chips were submitted for analytical testing upon packaging and after 6 weeks, 12 weeks and 24 weeks of 85° F. (29° C.) storage. Fried tortilla chip samples were tested for sensory descriptive and consumer preference testing initially upon packaging and at 6 weeks, 12 weeks and 24 weeks of 85° F. (29° C.) storage.

The analytical results of the frying oil samples showed typical variations in frying stability for the oils tested, with the best frying stability seen in the partially hydrogenated soybean oil sample. The analytical results of tortilla chips stored at 85° F. (29° C.) for up to 24 weeks gave an average fat uptake of 26.95% for tortilla chips fried in all samples. Anisidine values showed the highest results for chips fried in ULLS and the lowest results for chips fried in PH soybean oil. Similarly, Oxidative Stability Index was highest for chips fried in PH soybean oils and lowest for chips fried in ULLS.

Sensory data showed similar trends found in analytical testing of the fried tortilla chips. Descriptive sensory testing at the baseline of storage showed similar positive descriptors such as nutty, beany, corny, grassy and buttery for all samples tested. However, after 12 weeks of storage at 85° F. (29° C.), the tortilla chips fried in both RBD soybean oil and PH soybean oil both had higher intensity values for undesirable fishy and rancid descriptors than tortilla chips fried in Treus™ and ULLS. Moreover, after 24 weeks of storage at 85° F. (29° C.), the tortilla chips fried in RBD soybean oil, PH soybean oil and ULLS continued to show higher intensity values for undesirable fishy, rancid and painty descriptors than the tortilla chips fried in Treus™.

Descriptive sensory results were also validated with the sensory preference scores obtained from the consumer sensory panels (refer to FIG. 4). At baseline, consumer preference results showed equal or slightly higher preference for tortilla chips fried in Treus™ to tortilla chips fried in RBD and PH soybean oil. Moreover, tortilla chips fried in ULLS showed the highest consumer overall acceptability preference at the beginning of storage. However, the ULLS fried tortilla chips were significantly lower in preference after 24 weeks of storage at 85° F. (29° C.). The tortilla chips fried in Treus™ were highest in consumer preference after 12 weeks of storage at 85° F. (29° C.) for flavor and overall acceptability vs. all other tortilla chips prepared. Also, the Treus™ tortilla chips remained similar in preference to tortilla chips fried in PH soybean oil after 24 weeks of storage at 85° F. (29° C.).

Tortilla chips prepared in Treus™ showed acceptable storage stability for 24 weeks at 85° F. (29° C.) when compared to tortilla chips prepared in PH soybean oil. Sensory panels on Treus™ tortilla chips showed both an advantage in flavor and overall acceptability during storage. Tortilla chips prepared in ULLS showed high overall acceptability at the beginning of storage, but did not maintain acceptable storage stability for 24 weeks at 85° F. (29° C.).

### Example 2

### Cheese Curl Study

Cheese curls—a typical snack food—were made having the following formula:

| | |
|---|---|
| 66% Extruded Corn Curls | 9.9 lbs (4.5 Kg) |
| 24% Soybean oil | 3.6 lbs (1.6 Kg) |
| 10% Cheese seasonings | 1.5 lbs (0.68 Kg) |

Separate batches were made with the Treus™ and ULLS soybean oils described in Example 1. The cheese curls were packed and shipped to another facility for testing by a sensory panel of 60 people. The panel found no significant difference between the cheese curls made with the respective soybean oils. The panel noted typical flavor and textural qualities.

### Example 3

### Restaurant Simulation Frying Study

Samples of the Treus™ and ULLS soybean oils described in Example 1 were used as a frying medium to fry food in a setting simulating a restaurant for five days, following a typical frying procedure of a restaurant.

French fries prepared on the second day were evaluated by a sensory panel as described above. The product quality of both samples was typical and the panelists could not detect any difference between them.

Chicken nuggets were prepared on the fifth day of the study. Panelists could detect a difference but found neither objectionable. The product was judged very acceptable.

### Example 4

### Potato Chip Study

Potato chips were fried in the following oil samples:
a. Test—TREUS™ Soybean Oil
b. Control 1—Mid Oleic Sunflower Oil
c. Control 2—Winterized Cottonseed Oil
d. Control 3—Partially Hydrogenated Soybean Oil
   The fried samples were packaged, stored, and tested by a sensory panel after different storage intervals. The objective was to determine if a difference exists or if there is a preference for chips fried in Treus™ test soybean oil or the control oils in chip frying applications.

The fryer was broken in by frying potato chips through the fryer for 3 hours. The potato chips were prepared in the fryer at 368° F. to 378° F. (187° C. to 192° C.) for approximately 2 minutes and additional test oil was added as needed to the fryer. Potato chip samples were collected after between 3 hours and 6 hours of frying. 300 g potato chip samples treated with 12.5 g salt were packaged in sealed foil bags. Oil samples were collected after 3 hours of frying and after collecting all potato chip samples.

The potato chip samples were stored at 85° F. (29° C.) for accelerated storage testing. Typical frying oil analysis (oxidative stability index, free fatty acid, color, anisidine value, polymer, and food oil sensor) was conducted.

Prior to storage, a sensory panel found no significant differences among the four samples, i.e., Control 1, 2, and 3 and Test. For all attributes tested (appearance, texture, flavor and overall acceptability) the samples were rated as being between “neither like nor dislike” to “like slightly”. After six weeks of storage, a sensory panel again found no significant differences among the four samples.

The results of sensory evaluation after 12 weeks of storage were as follows.

| | | | | Overall |
|---|---|---|---|---|
| Sample | Appearance | Texture | Flavor | Acceptability** |
| Control 1 | 6.31 | 6.01 | 4.97 | 5.95 |
| Control 2 | 6.05 | 5.06 | 4.71 | 4.42 |
| Control 3 | 6.58 | 6.13 | 4.76 | 5.28 |
| Treus ™ | 6.05 | 6.06 | 4.92 | 5.07 |

The scale used for evaluation was 9=like extremely; 5=neither like nor dislike and 1=dislike extremely. Significant differences (P<0.05) between treatments were found in texture and overall acceptability (Note: ANOVA treatment effect for overall acceptability was at P=0.0878), i.e., Control 2 was found to a less desirable texture and was the least acceptable overall.

What is claimed is:

1. A method of frying food to provide low trans fatty acid content, comprising:
A. providing a frying medium consisting essentially of soybean oil that is essentially free of trans fatty acid and comprises from 0.2 wt. % to 3.5 wt. % linolenic acid, as a percentage of all fatty acid; and
B. frying food in the frying medium.

2. The method of claim 1, wherein the soybean oil comprises from 5 wt. % to 15 wt. % palmitic acid.

3. The method of claim 1, wherein the soybean oil comprises from 2 wt. % to 10 wt. % stearic acid.

4. The method of claim 1, wherein the soybean oil comprises from 20 wt. % to 50 wt. % oleic acid.

5. The method of claim 1, wherein the soybean oil comprises from 30 wt. % to 60 wt. % linoleic acid.

6. The method of claim 1, wherein the soybean oil comprises from 8 wt. % to 12 wt. % palmitic acid.

7. The method of claim 1, wherein the soybean oil comprises from 4 wt. % to 10 wt. % stearic acid.

8. The method of claim 1, wherein the soybean oil comprises from 25 wt. % to 40 wt. % oleic acid.

9. The method of claim 1, wherein the soybean oil comprises from 45 wt. % to 60 wt. % linoleic acid.

10. The method of claim 1, wherein the soybean oil comprises from 1 wt. % to 3 wt. % linolenic acid.

11. The method of claim 1, wherein the soybean oil comprises from 9 wt. % to 11 wt. % palmitic acid.

12. The method of claim 1, wherein the soybean oil comprises from 5 wt. % to 10 wt. % stearic acid.

13. The method of claim 1, wherein the soybean oil comprises from 26 wt. % to 35 wt. % oleic acid.

14. The method of claim 1, wherein the soybean oil comprises from 45 wt. % to 54 wt. % linoleic acid.

15. The method of claim 1, wherein the soybean oil comprises from 2 wt. % to 3 wt. % linolenic acid.

16. The method of claim 1, wherein the soybean oil comprises from 1 wt. % to 2 wt. % linolenic acid.

17. The method of claim 1, wherein the frying medium comprises 1-49 wt. % of cottonseed oil.

18. The method of claim 1, wherein the frying medium comprises 1-49 wt. % of palm oil.

19. A potato chip consisting essentially of potato solids and a frying medium according to claim 1.

20. A French fry consisting essentially of potato solids and a frying medium according to claim 1.

21. A tortilla chip consisting essentially of corn solids and a frying medium according to claim 1.

22. Fried food consisting essentially of a food, breading, and a frying medium according to claim 1.
